(19) United States
(12) Patent Application Publication
(10) Pub. No.: US 2003/0012951 A1
(43) Pub. Date: Jan. 16, 2003

(54) Analysis of isolated and purified single walled carbon nanotube structures

(76) Inventors: Mark S.F. Clarke, League City, TX (US); Pavel Nikolaev, Houston, TX (US); Sivaram Arepalli, Houston, TX (US)

Correspondence Address: Law Offices of John Gibson Semmes, Suite 201, 10220 River Road, Potomac, MD, 20854, US

(21) Appl. No.: 10/079,834

(22) Filed: Feb. 22, 2002

Related U.S. Application Data
(60) Provisional application No. 60/303,816, filed on Jul. 10, 2001.

(51) Int. Cl. B05D 1/00; B32B 5/02

(52) U.S. Cl. 428/398; 427/8; 427/372.2; 428/299.1; 428/293.7

(57) ABSTRACT

Methods of analyzing single-walled carbon nanotube structures dispersed in aqueous solutions with dispersal agents are accomplished by depositing the structures in solution on a suitable substrate and forming an array of isolated structures that are substantially free of contaminating material. Transmission electron microscopy and atomic force microscopy are utilized to characterize the isolated structures formed on the substrate.

### CROSS-REFERENCE TO RELATED APPLICATIONS

This application claims priority from U.S. Provisional Patent Application Serial No. 60/303,816, entitled “Isolation and Purification of Single Walled Carbon Nanotube Structures”, and filed Jul. 10, 2001.

### GOVERNMENT INTERESTS

This invention was made with Government support under contract NCC9-41 awarded by the National Aeronautics and Space Administration. The Government has certain rights in the invention.

### BACKGROUND OF THE INVENTION

1. Technical Field

The present invention relates to methods and corresponding products associated with analyzing aqueous dispersions of isolated and purified single-walled carbon nanotube (SWCNT) structures so as to effectively characterize individual SWCNT structures upon deposition of the structures on a suitable substrate.

2. Description of the Related Art

There has been significant interest in the chemical and physical properties of carbon nanotube structures since their discovery in 1991, due to the vast number of potential uses of such structures, particularly in the field of nanotechnology, composite materials, electronics and biology. Accordingly, there has been an increase in demand in recent years for carbon nanotube structures for research and application purposes, resulting in a desire to produce in an efficient manner single-walled carbon nanotube (SWCNT) structures that are free of impurities or contaminating material and easily separable for their proper characterization.

The three most common manufacturing methods developed for the production of SWCNT structures are high pressure carbon monoxide (HipCO) processes, pulsed laser vaporization (PLV) processes and arc discharge (ARC) processes. Each of these processes produce SWCNT structures by depositing free carbon atoms onto a surface at high temperature and/or pressure in the presence of metal catalyst particles. The raw material formed by these processes includes SWCNT structures formed as bundles of tubes embedded in a matrix of contaminating material composed of amorphous carbon (i.e., graphene sheets of carbon atoms not forming SWCNT structures), metal catalyst particles, organic impurities and various fullerenes depending on the type of process utilized. The entangled bundles of nanotubes that are formed by these manufacturing methods are extremely difficult to separate.

In order to fully characterize the physical and chemical properties of the SWCNT structures formed (e.g., nanotube length, chemical modification and surface adhesion), the contaminating matrix surrounding each structure must be removed and the bundles of tubes separated and dispersed such that each SWCNT structure may be individually analyzed. By maintaining an appropriate dispersal of individual SWCNT structures, characterization of the nanotubes formed may be accomplished in a mechanistic manner. For example, it is desirable to easily analyze and characterize dispersed SWCNT structures (e.g., determine change in nanotube length, tensile strength or incorporation of defined atoms into the carbon matrix of the SWCNT structure) based upon a modification to one or more elements of a manufacturing method.

It is further highly desirable to produce individual and discrete SWCNT structures in a form rendering the structures easily manipulable for use in the previously noted fields. At best, existing methodologies capable of physically manipulating discrete material components require elements that are measured on micron-level dimensions rather than the nanometer level dimensions of conventional partially dispersed and purified SWCNT structures. However, biological systems routinely manipulate with precise spatial orientation discrete elements (e.g., proteins) having physical dimensions on the order less than SWCNT structures. Thus, if SWCNT structures could be biologically derivatized so that biological tools, such as immunoglobulins or epitope-specific binding proteins, could be utilized to specifically recognize and physically manipulate the structures, the possibility of accurately spatially orienting of SWCNT structures becomes feasible. In order for this approach to be realized, the SWCNT structures must be individually separated from the raw material with the optimal functioning of biological compounds during both the biological SWCNT derivitization and the manipulation processes. In other words, the SWCNT structures must be produced as individual, freely dispersed structures in an aqueous buffer system that exhibits a nearly neutral pH at ambient temperatures in order to effectively manipulate the structures.

One form of analyzing SWCNT structures is through the use of transmission electron microscopy (TEM), a magnification process which allows one to visualize the SWCNT structures. TEM analysis requires the use of specialized FORMVAR® grids to capture nanotube material contained in solution in a manner analogous to a filter. As liquid containing the SWCNT structures passes through a FORMVAR® grid, a layer of SWCNT structures is captured and, even if dispersed (e.g., in an organic solvent), re-associates into ropes or bundles of nanotubes. A TEM image illustrated in FIGS. 1a and 1b shows an example of the condition of SWCNT structures after conventional purification and partial dispersion in a solution of methanol. The SWCNT structures of FIG. 1a form in tangled bundles upon deposition on a FORMVAR® grid. The image in FIG. 1b, which is a magnification of FIG. 1a, further shows the presence of metal catalyst impurities embedded within the nanotube rope structures (e.g., indicated by the arrows) which shows the inability of conventional purification methods in substantially removing contaminants from the SWCNT material.

Presently, the overwhelming problem for industrial and academic laboratories engaged in the use of carbon nanotubes for research as well as other applications is the limited source of discrete, completely separated SWCNT structures. Investigations into the vast potential of uses for SWCNT structures are being hampered by the limited supply of well characterized SWCNT material free of significant amounts of contaminants like amorphous carbon and metal catalyst particles.

Effective methods for isolating and purifying SWCNT structures in aqueous solutions have been disclosed in U.S. patent application Ser. No. 09/932,986, entitled “Production of Stable Aqueous Dispersions of Carbon Nanotubes” and filed Aug. 21, 2001. Briefly, that patent application describes a number of groups of dispersal agents capable of dispersing SWCNT structures from raw material in aqueous solutions and maintaining these dispersions over extended periods of time. A suitable dispersal agent is described as a reagent that exhibits the ability to interact with hydrophobic compounds while conferring water solubility. Examples of suitable dispersal agents described in U.S. patent application Ser. No. 09/932,986 are synthetic and natural detergents, deoxycholates, cyclodextrins, poloxamers, sapogenin glycosides, chaotropic salts and ion pairing agents. In solution, the dispersal agent surrounds and coats the individual SWCNT structures, allowing the structures to maintain their separation rather than bundling together upon separation of the structures from solution. While U.S. patent application Ser. No. 09/932,986 describes effective methods for dispersing SWCNT structures in solution, that application does not describe specific procedures for analyzing and characterizing the dispersed SWCNT structures formed in solution (e.g., determining dimensions of individual SWCNT structures).

Accordingly, there exists a need for appropriately analyzing and characterizing SWCNT structures dispersed in aqueous solutions with the above-described dispersal agents. Additionally, it is desirable to provide isolated and purified SWCNT structures removed from solution and disposed on a substrate while preventing the re-bundling of those SWCNT structures.

### SUMMARY OF THE INVENTION

Therefore, in light of the above, and for other reasons that will become apparent when the invention is fully described, an object of the present invention is to provide a method of analyzing and characterizing SWCNT structures dispersed in aqueous solution with a dispersal agent.

Another object of the present invention is to deposit the dispersed SWCNT structures on a suitable substrate while preventing any re-bundling of the structures.

A further object of the present invention is to separate the SWCNT structures from solution on the substrate while maintaining substantial isolation and preventing any re-bundling of the structures.

The aforesaid objects are achieved in the present invention, alone and in combination, by providing a method of analyzing SWCNT structures by depositing the structures dispersed in an aqueous solution including a dispersal agent on a substrate, where the substrate includes one of a grid surface, a glass surface and a polyethylene glycol surface, and forming an array of isolated structures on the substrate that are substantially free of contaminating material. The SWCNT structures are directly observed by transmission electron microscopy (TEM) and atomic force microscopy (AFM) analysis, with AFM analysis further utilized to characterize the SWCNT structures and determine SWCNT dimensions such as length and thickness. In one embodiment, the structures formed on the substrate are substantially longitudinally aligned with each other. Additionally, controlled removal of the aqueous solution (e.g., by evaporation) from the substrate surface results in the formation of highly ordered three-dimensional SWCNT geometries on the substrate rather than a disorganized, re-bundling of SWCNT material.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1a is a TEM image of raw material containing SWCNT structures and partially purified utilizing a conventional purification process.

FIG. 1b is an enlargement of the TEM image of FIG. 1a.

FIG. 2 is a TEM image of raft-like SWCNT structures that are substantially longitudinally aligned upon deposition onto a FORMVAR® grid of an aqueous methyl-β-cyclodextrin solution containing the dispersed structures.

FIGS. 3a-3d depict an atomic force microscopy (AFM) image of SWCNT structures deposited on a glass coverslip after removal of methyl-β-cyclodextrin from solution.

FIGS. 4a-4d depict an atomic force microscopy (AFM) image of SWCNT structures captured within a layer of PEG coated on the surface of a glass coverslip.

FIGS. 5a-5d depict an atomic force microscopy (AFM) image of a glass coverslip coated with polyethylene glycol and containing SWCNT raft-like structures formed after controlled evaporation of water from a methyl-β-cyclodextrin solution of dispersed SWCNT structures.

### DETAILED DESCRIPTION OF THE PREFERRED EMBODIMENTS

As noted above, SWCNT structures can be isolated and purified from raw material by dispersing the structures in an aqueous solution with a suitable dispersal agent. The dispersal agent effects a separation of the SWCNT structures from contaminating material such that the purified SWCNT structures exist as a dispersion of individual and discrete SWCNT structures in solution. Raw material is basically material formed by any process for producing single-walled carbon nanotubes, including, without limitation, the three processes described above. The raw material from which the SWCNT structures are isolated typically contains SWCNT structures embedded in a matrix of contaminating material. Contaminating material, or contaminants, are basically any impurities or other non-SWCNT components in the raw material including, without limitation, amorphous carbon and metal catalyst particles. The present invention builds upon the concepts described in U.S. patent application Ser. No. 09/932,986 and provides novel methods for analyzing and characterizing the SWCNT structures dispersed within the aqueous solution.

Suitable dispersal agents are effective in substantially solubilizing and dispersing SWCNT structures in an aqueous solution by increasing the interaction at the surface interface between each nanotube structure and water molecules in solution. A suitable dispersal agent is typically added to an aqueous solution in an effective amount to coat the SWCNT structures in solution, resulting in substantial purification and isolation of the structures in solution. The effective amount of dispersal agent will vary based upon the type of dispersal agent utilized in a particular application. A detailed description of various types of suitable dispersal agents and their chemical properties is detailed in U.S. patent application Ser. No. 09/932,986. Once a stable aqueous dispersion of SWCNT material is obtained, a direct observation technique is utilized to study the SWCNT structures dispersed in solution.

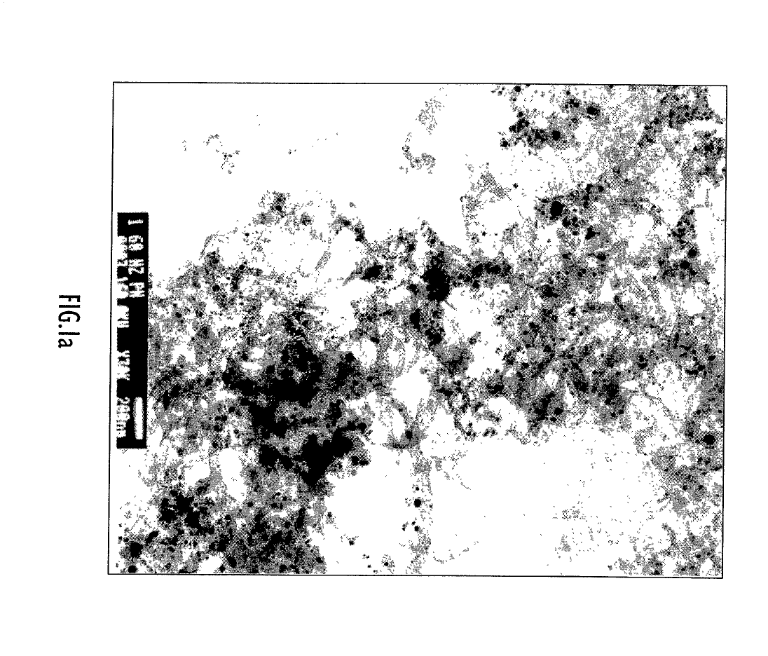

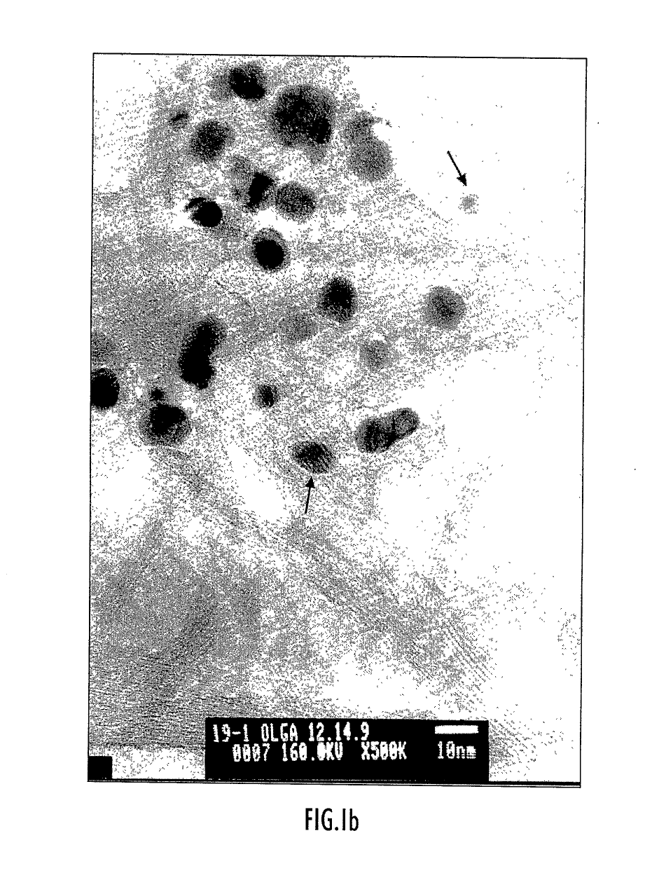

In preparation of direct observation analysis of the isolated and purified SWCNT structures by, e.g., TEM or AFM, the structures dispersed in solution are initially deposited onto a suitable substrate. In one embodiment, the SWCNT structures coated with dispersal agent are deposited on a suitable grid (e.g., a FORMVAR® grid) for TEM analysis. The grid surface serves to filter the SWCNT structures from solution passing through the grid. The SWCNT structures deposited on the grid form substantially longitudinally aligned and parallel raft-like structures that are free of any contaminating material. The alignment of SWCNT structures into substantially parallel rafts occurs due to repulsive forces induced by the dispersal agent coating the surfaces of the structures. The highly ordered and separated alignment of individual nanotubes facilitates easy characterization and manipulation of the SWCNT structures. As previously noted, conventional methods for isolating nanotube structures on a surface such as a FORMVAR® grid have led to a tangled mess of nanotubes having contaminated material embedded therein, as clearly indicated in FIGS. 1a and 1b. In contrast, the isolation and purification methods described here result in a novel formation of raft-like SWCNT structures aligned in a suitable array that facilitates easy characterization of individual structures.

Another method for forming raft-like SWCNT structures involves depositing the structures dispersed in aqueous solution on a glass coverslip for AFM analysis. When water is subsequently removed at a controlled rate from the coverslip to dry the SWCNT structures, the structures maintain their isolated configurations and do not become entangled or bundled together. A further method for forming raft-like SWCNT structures is to immobilize the structures on a poly-hydroxylated surface. For example, dispersal agent coated SWCNT structures can be deposited on a surface coated with a low molecular weight polyethylene glycol or PEG (e.g., CarboWax). The PEG surface captures the SWCNT structures in their isolated form and prevents the re-bundling of the structures upon removal of solution from the surface. Subsequent AFM analysis reveals that the SWCNT structures remain in isolated form after the surface is dried to remove the solvent from the structures.

Deposition of dispersal agent coated SWCNT structures on a surface such as those previously described provides a permanent record of the structures in isolated form, which is important for conducting characterization studies of the structures utilizing AFM analysis. AFM analysis provides a highly accurate determination of the dimensions of single SWCNT structures, including overall length and diameter. AFM further provides the spatial resolution required to distinguish individual SWCNT structures from nanotube bundles or ropes and to allow individual SWCNT structures to be imaged along their full lengths. Utilizing AFM analysis, the SWCNT structures separated from raw material as described here can be easily visualized in their isolated and purified form having lengths on the order of about 10-15 μm. It is noted that previous reported SWCNT lengths utilizing other known isolation and purification techniques are on the order of only about 150-250 nm. Additionally, AFM analysis reveals surface-deposited SWCNT structures coated with a dispersal agent yield raft-like formations in which both single layers and multiple layers, up to 4 layers thick, form on the substrate surface.

In the examples described below, taurocholic acid (TA) and/or methyl-β-cyclodextrin (MβC) are utilized as exemplary dispersal agents for direct analysis of stable aqueous dispersion of SWCNT structures. However, it is noted that any of the dispersal agents described in U.S. patent application Ser. No. 09/932,986 may be utilized with the methods described here for analyzing and characterizing SWCNT structures.

### EXAMPLE 1

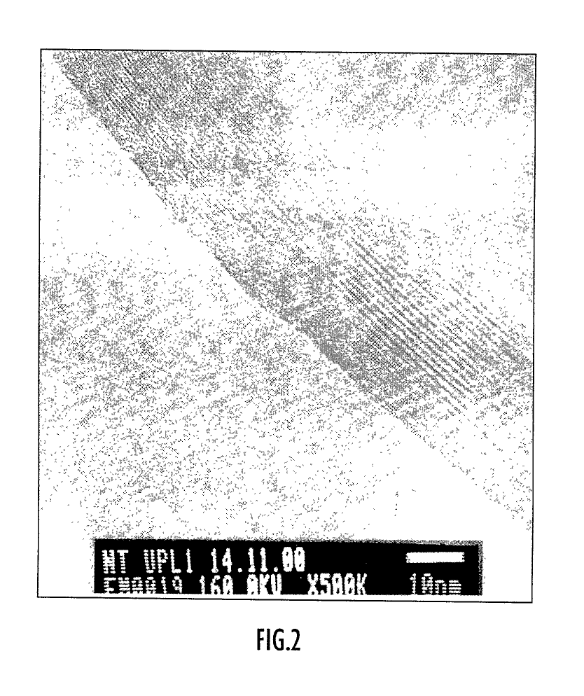

Stable samples of SWCNT structures dispersed in aqueous solutions with a dispersal agent were initially prepared according to the specific method described in Example 2 of U.S. patent application Ser. No. 09/932,986, where MβC and taurocholic acid (TA) were each utilized in individual samples as the dispersal agents. The TA and MβC solutions containing SWCNT structures were then subjected to TEM analysis, wherein a 50 μl sample of each solution was deposited onto a FORMVAR® grid and the liquid was drawn through the FORMVAR® membrane by placing a clean absorbent pad beneath the grid (i.e., by capillary action). As the liquid was drawn through the grid, SWCNT structures formed on the membrane. Images of SWCNT structures were taken at locations where the structures spanned the holes in the membrane. An exemplary TEM image of the grid is depicted in FIG. 2. The images revealed highly organized SWCNT structures that were aligned in parallel raft-like formation, rather than tangled together in bundles or ropes. The structures were also free of contaminating materials such as metal catalyst particles and other impurities. TEM analysis further revealed that the coating of either TA or MβC on the SWCNT structures promotes repulsion between the individual nanotubes, resulting in spatial separation and parallel raft-like formations of individual SWCNT structures wherein the least amount of surface area contact between coated nanotubes is tolerated in the absence of water.

Samples for use in Examples 2-4 below were initially prepared according to the specific method described in Example 4 of U.S. patent application Ser. No. 09/932,986, where each of the samples includes MβC as the dispersal agent and excess dispersal agent is removed from each sample by size exclusion column chromatography in combination with centrifugation.

### EXAMPLE 2

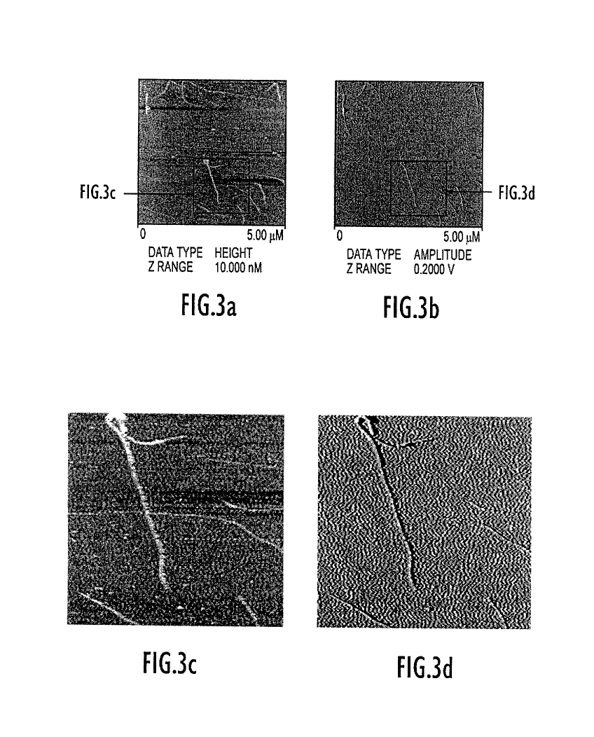

A sample containing dispersed SWCNT structures and prepared as described above was continuously washed in order to remove as much MβC as possible prior to AFM analysis. Specifically, the sample was subjected to repeated centrifugation followed by removal of the resultant supernatant and resuspension in distilled water. The centrifugation and washing process was repeated a total of four times to remove any excess MβC from the dispersion. A 25 μl aliquot of the final washed sample was deposited on a 12 mm glass coverslip and allowed to air dry at 37° C. for one hour. When this surface was analyzed utilizing AFM, imaging revealed the presence of both discretely separated SWCNT structures about 1.4 nm in diameter and larger ropes or bundles of nanotubes about 6-10 nm in diameter. A discretely separated SWCNT structure obtained from this method is depicted in the AFM image of FIGS. 3a-3d (FIG. 3a depicts the AFM height profile, FIG. 3b depicts the AFM amplitude profile, and FIGS. 3c and 3d are magnifications of FIGS. 3a and 3b, respectively). This example indicates that removal of the majority of MβC from solution by repeated washing resulted in the re-association of some of the SWCNT structures back into ropes or bundles, while other SWCNT structures remained separated and in isolation. In effect, this example illustrates that dispersal of SWCNT structures in an aqueous solution will decrease if the dispersal agent is reduced below an effective and threshold amount in solution thereby reducing the amount of dispersal agent available to interact with the surface of the SWCNT structures.

### EXAMPLE 3

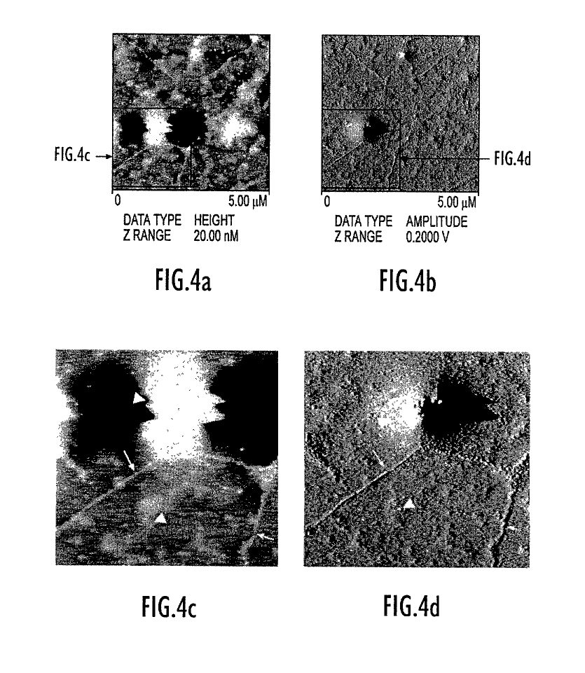

An AFM surface was developed to specifically capture MβC-coated SWCNT structures in a suitable manner to effect proper characterization of the structures. Specifically, the surface of a 12 mm round glass coverslip was coated with a layer of low molecular weight polyethylene glycol, PEG 200 (sold commercially as Carbowax). Twenty five μl of an aqueous MβC sample containing dispersed SWCNT structures, prepared as described above, was deposited on the coverslip, quickly washed to remove excess MβC and then allowed to air dry at room temperature. When the dried surface was analyzed using AFM imaging, discretely separated SWCNT structures were observed as being attached to the PEG coated surface as illustrated by the representative AFM image depicted in FIGS. 4a-4d (FIG. 4a depicts the AFM height profile, FIG. 4b depicts the AFM amplitude profile, and FIGS. 4c and 4d are magnifications of FIGS. 4a and 4b, respectively). The arrows in FIGS. 4c and 4d identify discretely separated SWCNT structures, whereas the arrow heads identify PEG adsorbed on the glass substrate. The AFM images further reveal SWCNT structures from 10-15 μm in length, i.e., verifying that the dispersal methods used here yield SWCNT structures of much greater lengths than the typical 150-250 nm lengths yielded by conventional isolation and purification techniques. Thus, this example illustrates that SWCNT structures dispersed in aqueous dispersal agent solutions may be fully characterized by capturing the structures on poly-hydroxylated surfaces such as a PEG coated glass coverslip.

### EXAMPLE 4

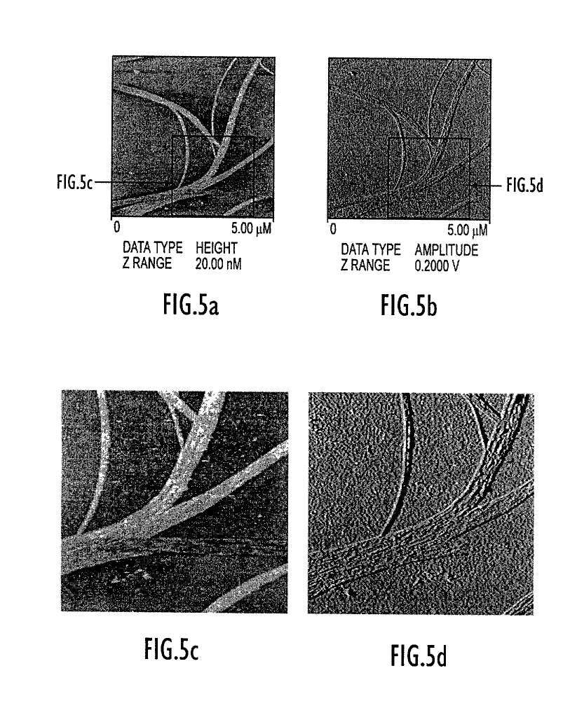

A method of controlled removal by evaporation of the aqueous solution from dispersal agent coated SWCNT structures was conducted to observe the effect on the dispersion of the structures. Specifically, 25 μl samples of an aqueous MβC solution, prepared as described above, were deposited on 12 mm round glass coverslips. The aqueous solutions were allowed to slowly evaporate by air drying over about a 12 hour period. Subsequent AFM analysis of each coverslip revealed MβC coated discrete SWCNT structures forming highly organized rafts or tapes as illustrated in a representative AFM image depicted in FIGS. 5a-5d (FIG. 5a depicts the AFM height profile, FIG. 5b depicts the AFM amplitude profile, and FIGS. 5c and 5d are magnifications of FIGS. 5a and 5b, respectively). The observed raft or tape SWCNT structures extended hundreds of microns across the substrate and had various widths ranging up to 1 μm but were no more than 6 nm in height. Additionally, it was observed that both single layers and multiple layers up to four layers thick of SWCNT structures had formed into highly ordered three-dimensional geometries resembling a crystal structure. Thus, the data confirms that controlled removal of the aqueous solution from the dispersal agent coated SWCNT structures results in the formation of purified and highly ordered, raft-like SWCNT structures rather than ropes or bundles of entwined nanotubes.

The present invention provides a significant improvement in the techniques used to directly analyze and characterize dispersions of SWCNT structures in an aqueous solvent using a dispersal agent. In addition, the methods described here produce novel arrays of individual and isolated SWCNT structures on a substrate substantially absent any contaminating material, rather than ropes or bundles of entangled structures. Furthermore, controlling the removal of water from a stable aqueous SWCNT dispersion deposited on a substrate results in the formation of an aligned crystalline form of SWCNT material.

Having described novel methods and products relating to analyzing and characterizing isolated and purified SWCNT structures dispersed in aqueous solution with a dispersal agent, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed:

1. A method of analyzing single-walled carbon nanotube structures comprising:
depositing the structures dispersed in an aqueous solution including a dispersal agent on a substrate, wherein the substrate comprises one of a grid surface, a glass surface and a polyethylene glycol surface;
forming an array of isolated structures on the substrate, wherein the isolated structures are substantially free of contaminating material; and
analyzing the array of isolated structures formed on the substrate.

2. The method of claim 1, wherein the forming of the array includes:
removing water from the solution containing dispersed structures deposited on the substrate.

3. The method of claim 1, wherein the substrate includes a FORMVAR® grid, and the forming of the array includes:
removing solution from the structures deposited on the grid surface by drawing the solution through the FORMVAR® grid; and
forming a plurality of substantially longitudinally aligned and separated structures.

4. The method of claim 1, wherein the forming of the array includes:
drying the aqueous solution for a predetermined time period to remove water from the structures deposited on the substrate.

5. The method of claim 1, wherein the analyzing the array of isolated structures formed on the substrate includes determining at least one of a physical dimension of at least one isolated structure and a physical alignment between at least two isolated structures.

6. The method of claim 1, wherein the analyzing the array of isolated structures includes utilizing at least one of transmission electron microscopy and atomic force microscopy.

7. The method of claim 6, wherein atomic force microscopy is utilized to determine a length of at least one of the isolated structures.

8. A method of producing a single-walled carbon nanotube product comprising:
depositing single-walled carbon nanotube structures dispersed in an aqueous solution including a dispersal agent on a substrate, wherein the substrate comprises one of a grid surface, a glass surface and a polyethylene glycol surface; and
removing water from the solution containing structures deposited on the substrate to form an array of isolated structures substantially free of contaminated material.

9. The method of claim 8, wherein at least one of the isolated structures disposed on the substrate has a length greater than 250 nm.

10. The method of claim 8, wherein at least one of the individual structures disposed on the substrate has a length of at least about 10 μm.

11. A single-walled carbon nanotube product made by the method of claim 8.

12. A single-walled carbon nanotube product comprising an array of isolated single-walled carbon nanotube structures substantially free of contaminating material and disposed on a substrate comprising one of a grid surface, a glass surface and a polyethylene glycol surface.

13. The product of claim 12, wherein the array includes a plurality of substantially longitudinally aligned structures.

14. The product of claim 12, wherein the substrate includes a FORMVAR® grid.

15. The product of claim 12, wherein at least one of the structures disposed on the substrate has a length greater than 250 nm.

16. The product of claim 12, wherein at least one of the structures disposed on the substrate has a length of at least about 10 μm.
